(19) United States
(12) Patent Application Publication
(10) Pub. No.: US 2016/0013999 A1
(43) Pub. Date: Jan. 14, 2016

(54) LOGGING SERVER APPLIANCE FOR HOSTED SYSTEM COMMUNITIES AND OPERATION CENTER

(71) Applicant: IGT, Reno, NV (US)

(72) Inventors: Eugene T. BOND, Trabuco Canyon, CA (US); John E. BURDEN, Las Vegas, NV (US); Gandalf G. HUDLOW, San Marcos, CA (US)

(73) Assignee: IGT, Reno, NV (US)

(21) Appl. No.: 14/325,532

(22) Filed: Jul. 8, 2014

(51) Int. Cl. H04L 12/26; H04L 29/08; G06F 17/30

(52) U.S. Cl. CPC H04L 43/08; G06F 17/30914; H04L 67/10

(57) ABSTRACT

Operational data is managed by a system. Real-time operational data is collected at a plurality of client systems. At each client system, the collected real-time operational data is normalized into a common format to thereby provide a plurality of common data objects, each common data object is qualified for an assignment of one or more tags based on qualification rules, one or more corresponding tags is assigned to each common data object, and the qualified common data objects are prioritized according to a predetermined rule to identify high priority common data objects and low priority common data objects. The high priority qualified common data objects are then sent to a central server.

### COPYRIGHT NOTICE

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

1. Field of the Invention

The present invention relates in general to gaming machines and systems, and more particularly to mechanisms for collecting and processing data at a central location from various client servers.

2. Description of the Related Art

Electronic gaming machines (EGMs), such as slot machines and video poker machines, have been increasing in popularity over the last several years. As technology continues to advance, the EGMs increasingly are computer based and contain multiple external interfaces for connecting with communications devices, allowing them to operate in server-client network configurations. Typically in such configurations, a server stores and executes software components, sending video output to a client terminal for display. The client terminal receives user input and sends the input to the central server for game interaction and casino management interaction. Additionally, one or more servers may generate the game of chance from an EPROM or other form of non-volatile memory, and the software associated with the EGMs undergoes a validation process in which the EPROM at the server is validated.

### SUMMARY OF THE DESCRIBED EMBODIMENTS

Generally, because each client server may be located and/or run by different gaming institutions, servicing software issues have been a challenge. In particular, each client server stores operational data in different formats. As a result, interpreting and sorting through the data is relatively time-consuming. Additionally, because of the sheer volume of operational data that is typically stored, users usually have to comb through each individual file or database for errors, warnings, and the like in order to diagnose a problem. Moreover, as logs tend to be overwritten or purged due to disk space limitations, data that may be useful for diagnosis may disappear after a period of time.

Accordingly, a need exists for an improved mechanism for managing and monitoring operational data from client servers in order to identify and service issues that may arise thereon. A need also exists for a mechanism to collect operational data from multiple client servers that may be stored in multiple formats and normalize the data to a common format and perform statistical analyses on the data. Moreover, a need exists for a mechanism which may be community controlled, to allow a promotion or demotion of relevancy of a particular item of operation data.

An appliance is now being provided to address the above-mentioned needs. In an embodiment, by way of example only, the appliance can take the form of a method of managing operational data. The method includes collecting real-time operational data at a plurality of client systems. Additionally, at each client system the collected real-time operational data is normalized into a common format to thereby provide a plurality of common data objects, each common data object is qualified for an assignment of assigning one or more corresponding tags based on qualification rules, one or more corresponding tags is assigned to each common data object, and the qualified common data objects are prioritized according to downloaded rule set to identify high priority common data objects and low priority common data objects. The high priority qualified common data objects are sent to a central server.

Other systems and computer program product embodiments are provided and supply related advantages.

The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 is a block diagram illustrating modules within a cloud computing network, in which aspects of the present invention may be realized;

FIG. 2 is a block diagram illustrating the architectural components of a cloud computing network, in which aspects of the present invention may be realized;

FIG. 3 is a block diagram illustrating various modules included in a logging server appliance, in which aspects of the present invention may be realized;

FIG. 4 is a system in which the logging server appliance of FIG. 3 may be implemented, in which aspects of the present invention may be realized;

FIG. 5 is a flow diagram of a method of managing data objects using the logging server appliance, in accordance with an embodiment; and

FIGS. 6-8 are screenshots of a logging server appliance interface, in accordance with an embodiment.

### DETAILED DESCRIPTION OF THE DRAWINGS

The collection of real-time operational data from different systems, for example, from on-premise systems (client sites) and off-premise systems (host sites) and/or newer and older systems, is a daunting task. The operational data, which includes application logs, real-time logging, performance data, user-click-through data, and player experience data, typically is stored in a database, and may include an overwhelmingly large amount of data. As such, the data is collected for a finite period of time and, due to disk space limitations and because data indicating error may not be distinguishable from normal operating data, at the expiration of the time period must be overwritten or purged.

In order to better manage the collection and analysis of the real-time operational data, an inventive logging server appliance is now being provided. The logging server appliance is implemented on both on-premise and off-premise systems and is capable of receiving operational data from log publishers and data publishers at the on-premise systems. The appliance sends the data to the off-premise system to analyze the data, perform comparative analysis, and monitor software system health based on the received operational data. Further, the logging server appliance performs trending analyses across a software product family as a whole or by specific application and may perform the analyses across an entire cloud-based community (for example, across all hosted clients of the community). The trending analyses can be detailed per client, per site within the client or per application used by the client. As a result, issues that may be detected in the software product may be pinpointed to installation, configuration, or other processes and/or may be identified as affecting a single client instance or system-wide.

As part of the operational data management, the logging server appliance at the on-premise system normalizes the operational data into a common format (common data objects) and then executes an external rule set that is defined externally to determine which ones of the data objects are kept and which are to be discarded. For example, each data object is evaluated based on the external rule set and qualified. Once qualified, the common data objects are tagged with identifiers and stored for transmission to the logging server. The tags may be associated with a resolution, and in some embodiments, the resolution may be communicated to a corresponding on-premise system prompting an automatic run resolution script to resolve an issue.

The logging server appliance also provides visibility of the operational data and the ability for the community to interact with the data. According to an example, the priority of one or more rules in the external rule set is determined by community votes. In another example, the logging server appliance tags data objects with meaningful topics that can be used in the discovery of a trend and displays the tagged data objects to the community. Additionally, the logging server appliance enables the community to provide feedback relating to the data and/or trend. For example, the community can interact with data objects by, among other things, voting up or down whether they want to retain or discard a particular data object, by turning a phrase, keyword, or tag into a topic, by placing weights on data objects, by adding comments to the data object, and the like.

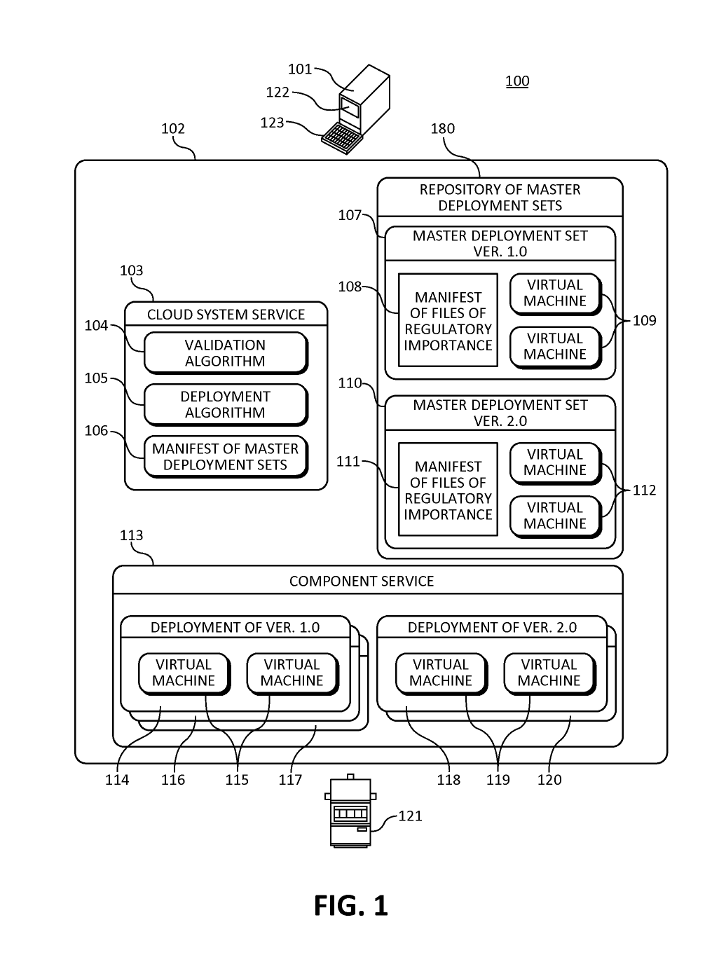

The logging server appliance is deployed via a cloud computing network, according to an embodiment. FIG. 1 is a block diagram illustrating modules within a cloud computing network 100, in which aspects of the present invention may be realized. The cloud computing network 100 includes a cloud-based on-demand service environment 102 that provides a cloud system service 103 to a client terminal 101.

In an embodiment, the cloud system service 103 includes a validation algorithm 104 for validating a deployment, a deployment algorithm 105 for deploying a master deployment set, and a manifest of master deployment sets 106. In accordance with an embodiment, the validation algorithm 104 includes a secure hashing algorithm and a validation seed generator. The manifest of master deployment sets 106 may contain a listing of master deployment sets that the cloud system service 103 may access. In the example shown in FIG. 1, the cloud system service 103 contains two master deployment sets 107 and 110, which are listed in the manifest of master deployment sets 106. In some embodiments, the two master deployment sets 107 and 110 represent different versions of software on the virtual machines within the master deployment sets. For instance, master deployment set 107 corresponds with Version 1.0 while master deployment set 110 corresponds with Version 2.0.

The master deployment sets are stored in a repository of regulatory approved master deployment sets 180. The repository of regulatory approved master deployment includes one or more master deployment sets that have received regulatory approval in one or more jurisdictions. For instance, the repository of regulatory approved master deployment sets 180 includes the master deployment sets 107 and 110. In some examples, regulatory approved software may incorporate jurisdictional information for the jurisdiction in which the software has been approved.

Each master deployment set further includes a manifest of files of regulatory importance and one or more virtual machines. For example, the master deployment set 107 includes a manifest of files of regulatory importance 108 and virtual machines 109. Similarly, the master deployment set 110 includes a manifest of files of regulatory importance 111 and master virtual machines 112.

The manifest of files of regulatory importance 108 and 111 includes a list of files that under wager gaming regulatory rules cannot change when the master deployment sets 107 and 110 are deployed. In some implementations, each deployed instance of a master deployment set provides the component service 113 to different regulatory jurisdictions with different validation requirements. In one example, the manifest of files of regulatory importance 108 may be configured to incorporate jurisdictional regulatory data for at least three jurisdictions corresponding to the locations served by the deployments 114, 116, and 117, thereby enabling the cloud computing network 100 to provide the component service 113 to the gaming machine client terminal 121 located in one of the three jurisdictions.

In the example shown in FIG. 1, the master deployment set version 1.0 107 has three deployed instances 114, 116, and 117. The master deployment set Version 2.0 110 has two deployed instances 118 and 120. Each deployed instance includes virtual machines corresponding with virtual machines in the master deployment set. For instance, the deployment 114 includes virtual machines 115 corresponding with virtual machines 109 in the master deployment set Version 1.0 107. The Deployment 118 includes virtual machines 119 corresponding with master virtual machines 112 in the master deployment set Version 2.0 110.

In an embodiment, in addition to including gaming software components for generating the wager game, operating the wager game, generating random numbers, or any combination thereof, the one or more virtual machines in the deployment and the corresponding one or more master virtual machines in the master deployment set include the logging server appliance. For example, components of the logging server appliance that are to be deployed on-premise are included in one or more of the virtual machines, while the logging server appliance components for use off-premise are included in the same or on different ones of the virtual machines.

In another embodiment, the one or more virtual machines in the deployment and the corresponding one or more master virtual machines in the master deployment set include casino management software components. Examples of casino management software components include components for player tracking, ticketing, cashless transfers, slot accounting, progressives, bonusing, patron management, machine accounting, or any combination thereof.

In still another embodiment, the one or more virtual machines in the deployment and the corresponding one or more master virtual machines in the master deployment set include both gaming software components and casino management components.

As discussed above, a master deployment set may be deployed to one or more component servers to provide the component service 113. When the one or more virtual machines in the deployment and the corresponding one or more master virtual machines in the master deployment set include gaming software components, the component service may also be referred to as a “gaming service.” When the one or more virtual machines in the deployment and the corresponding one or more master virtual machines in the master deployment set include casino management software components, the component service may also be referred to as a “casino management service.”

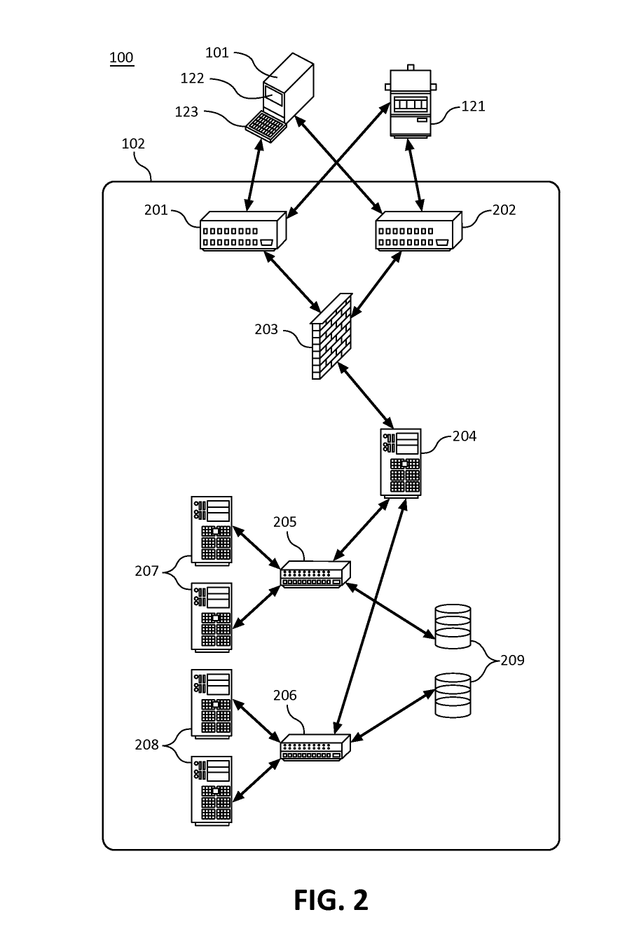

FIG. 2 is an illustration of the architectural components of a cloud computing network, configured according to some implementations. A client terminal 101 and a gaming machine client terminal 121 communicate with the cloud-based on-demand service environment 102 via one or more edge routers 201 and 202 and a firewall 203. A load balancer 204 distributes server load to one or more validation servers 207 and one or more component servers 208 via server switches 205 and 206. Data sources 209 communicate with the validation servers 207 and the component servers 208 via server switches 205 and 206.

The client terminal 101 may be operated by an authorized user to access the cloud system service. In some implementations, client terminal 101 is an apparatus with a display device 122, an input device 123, and a web browser communicatively coupled with an internet connection. The client terminal in some implementations may be a computer, a laptop, a tablet, or a smart phone. In some implementations, the client terminal 101 may be located within cloud-based on-demand service environment 102 with the cloud system service 103 running as a local application. For example, the client terminal 101 may be a local terminal attached with one of the validation servers 207.

The gaming machine client terminal 121 may be owned by a customer or subscriber of one or more of the component services. One example of a customer or subscriber may include a gaming establishment. The gaming machine client terminal may be operated by a patron of the gaming establishment to access the wager gaming service. In an embodiment, the gaming machine client terminal may be a computing device or gaming machine located on the floor of the gaming establishment. In other implementations, the gaming machine client terminal may be a desktop, a mobile computing device, a laptop, PDA, a tablet or a smart phone. In another embodiment, the gaming machine client terminal is an apparatus with a display device, an input device, and a web browser communicatively coupled with an Internet connection.

The gaming machine client terminal 121 may further operate in various configurations depending on the implementation of the component service. In an example, if the component service is the casino management service, the gaming machine client terminal may be configured to operate wager games in a standalone configuration or in a client/server configuration (i.e. the wager game is not provided by the component service).

In another embodiment, if the component service is the gaming service, the gaming machine client terminal may be configured to operate casino management software in a standalone configuration or in a client/server configuration (i.e. the casino management software is not provided by the component service). In an example, the component service includes the gaming service and the casino management service. The gaming service and the casino management service may be provided to the gaming machine client terminal without requiring the need for specialized software being installed on the gaming machine client terminal.

The edge routers 201 and 202 and the firewall 203 ensure that only authorized remote devices may access the cloud-based on-demand service environment 102. In some implementations, the edge routers 201 and 202 employ the Border Gateway Protocol for Internet packet routing. The edge routers may include a table of IP networks or prefixes which block unauthorized Internet traffic. The firewall 203 may be configured with predetermined settings to protect the inner components of the cloud-based on-demand service environment 102, such as the validation servers 207, the component servers 208, and the data sources 209. The firewall 203 may also act as a packet filter, an application gateway, a stateful filter, a proxy server, or any other type of firewall.

The load balancer 204 distributes server load between the one or more validation servers 207 and the one or more component servers 208. The load balancer 204 helps the cloud-based on-demand service environment 102 achieve optimal resource utilization, maximize throughput, minimize response time, and avoid overload. Using multiple servers with load balancing, instead of a single server, may increase reliability through redundancy. The load balancer 204 may include multilayer switches to analyze and forward traffic to the desired location.

The validation servers 207 host the cloud system service 103 shown in FIG. 1. Although two validation servers are shown in FIG. 2, any number of physical servers can be configured to provide the cloud system service 103 depending on the factors such as cost and volume of traffic. The component servers 208 host the component service 113 shown in FIG. 1. Although two component servers are shown in FIG. 2, any number of physical servers can be configured to provide the component service 103 depending on the factors such as cost and volume of traffic.

The server switch 205 facilitates communication between the validation servers 207 and the client terminal 101, and the validation servers 207 and the data sources 209. The server switch 206 facilitates communication between the component servers 208 and the gaming machine client terminal 121, and the component servers 208 and the data sources 209. Although the implementation shown in FIG. 2 uses different servers 207 and 208 and different server switches 205 and 206 for the cloud system service and the component service respectively, those of skill in the art will appreciate that other implementations are possible within the scope and spirit of the disclosed subject matter. For example, both services may be hosted on a single server or same sets of servers and facilitated by the same server switch or same sets of server switches. Those of skill in the art will appreciate that numerous physical server configurations can be utilized to provide the component service 113 and the cloud system service 103 depending on factors such as cost and volume of traffic.

The data sources 209 are configured to store master deployment sets, such as the master deployment sets 107 and 110 in FIG. 1. In an embodiment, the data sources 209 are components of a cloud-based on-demand database system shared by multiple subscribers of the component service 113, other on-demand services that may be provided by the cloud-based on-demand service environment 102, and local applications within the cloud-based on-demand service environment 102. The on-demand database system may employ a multi-tenant approach, a virtualized approach, or any other type of database approach.

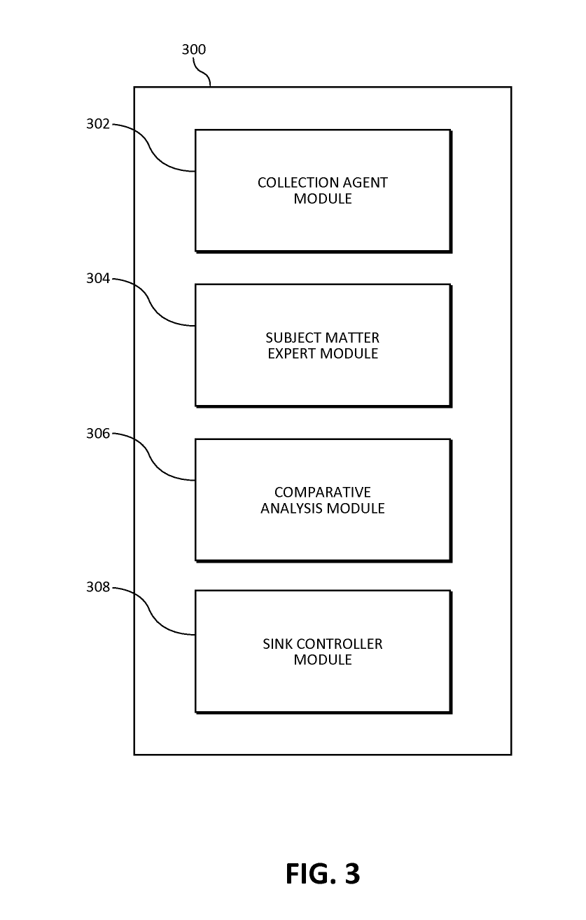

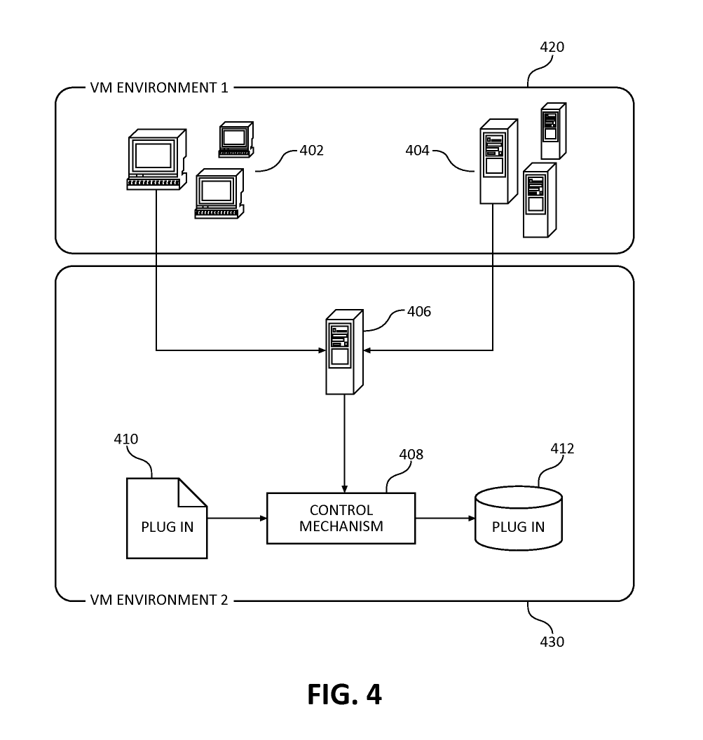

As noted briefly above, one or more of the virtual machines includes one or more components of the logging server appliance. Turning now to FIGS. 3 and 4, a block diagram of a logging server appliance 300 is illustrated and a system 400 in which the logging server appliance 300 may be implemented are provided, according to an embodiment. The logging server appliance 300 generally includes a collection agent module 302, a subject matter expert module 304, a comparative analysis module 306, and a sink controller module 308. The collection agent module 302 includes instructions that, when executed, cause a processor to read data from on-premise workstations 402 in and servers 404 in a virtual machine environment 1 420. In an embodiment, because the workstations 402 and servers 404 may be located and or operated by a variety of different users and/or owners, the data may be stored in more than one format. As such, the collection agent module 302 reads the data in its original format and then translates the data into common data objects. For example, collection agent module 302 collects data which includes but is not limited to, errors, warnings, and other information, and is also stored in one or more logs, each having a different log format, by reading those logs published from applications, such as operating system and/or game applications and/or system applications, that reside on the on-premise workstations 402 and/or servers 404. The collection agent module 302 operates with the log publishers of the on-premise workstations 402 and/or servers 404 to normalize the data into a common format.

The collection agent module 302 also includes instructions to qualify each common data object for an assignment of one or more tags based on qualification rules. The qualification rules are part of an external rule set that are defined externally (for example, by a community, as will be discussed in further detail below) and are pushed to the on-premise systems and used to identify which of the data objects are to be sent from one or more of the on-premise workstations 402 to an off-premise server 406 in another virtual machine environment (e.g., virtual environment 2 430). In an embodiment, the rules define how long the logs are stored, how much data is sent to the off-premise server 406, and which data is received by the off-premise server 406. In an embodiment, each rule is associated with a specific tag, and the collection agent module 302 implements the rules by assigning one or more corresponding tags to each common data object and prioritizing the tagged common data objects. To prioritize the data objects, additional rules included in the external rule set are applied to the tagged common data objects to identify high priority common data objects and low priority common data objects. The collection agent module 302 then sends the high priority qualified common data objects to the off-premise server 406. The collection agent module 302 discards the low priority qualified common data objects. According to an embodiment, the off-premise server 406 includes a common interface that operates with the collection agent module 302 to interface with the log publishers of the on-premise systems 402, 404. As such, the log publishers send the collected errors, warnings, information, and debug data to the logging server appliance via the common interface. The common interface is available in many protocols, such as http, socket I/O, udp, and the like.

The subject matter expert module 304 analyzes and interprets the high priority common data objects. In an embodiment, the subject matter expert module 304 includes instructions that, when executed by a processor, cause the processor to identify the corresponding tag of a high priority common data object and, based on the corresponding tag, provide a script for resolution of an issue associated with the corresponding tag. For example, a tag indicating a slow response time may cause the subject matter expert module 304 to run an auto-resolution script to resolve an error. Examples include, but are not limited to, sending an email to an operator indicating the error, escalation of the error, running a resolution to correct the error, and the like.

The comparative analysis module 306 includes instructions to identify trends that occur across all of the high priority common data objects. In this way, errors that may be occurring at multiple sites across an entire install base are able to be identified. In an embodiment, a trending algorithm is employed to discover trends. The trending algorithm formula includes factors such as topic frequency, topic velocity (the rate at which topics are reported), and an external weight. In an example, the comparative analysis module 306 compares data objects received at different times, for example, after deployment of Version 1.0 and after deployment of Version 2.0, or after changes are made to hardware or other software configurations, and determines a cause of an error based, in part, on the changes. The identified trends are then presented to the community.

The sink controller module 308 is a community external control mechanism 408 that provides a platform for the community to dictate and control the data object and the presentation of trends that are identified from the data. The users also interact with the presented data and/or to interact with other users in the community. In an example, sink controller module 308 receives input from various users overseeing operation of the on-premise workstations 402 and servers 404. In an embodiment, the users use the sink controller module 308 to vote up or down the storing or weight of data objects so that the community controls the volume of data objects to keep and an aging rate of a particular data object. By controlling the aging rate of data objects, the system self-maintains the storage of data objects by gradually purges off older and/or irrelevant log data thereby maintaining a log store of only relevant information. In another embodiment, the users use the sink controller module 308 to vote up or down the application or inclusion of rules in a rule engine for qualifying data objects, votes up or down particular data objects by adjusting the weight of the data object based on relevancy, frequency of occurrence, and/or other factors, to vote up or down an importance of trending topics by identifying certain keywords or phrases as topics, and the like. The sink controller module 308 uses various plug-ins 410, 412 to either store or manipulate input or other data. In an embodiment, a log write plug-in 410 includes instructions for customizing the storing and displaying of log data. In accordance with an embodiment, the log writer plug-in 410 does so by providing data via text log files. In another embodiment, another log writer plug-in 412 uses a database storage to write and store logs.

Although illustrated as residing at separate locations, the modules of the logging server appliance 300 are available for use at various on-premise and off-premise locations, either physically downloaded at the locations, in a cloud-based extension of software running in a central data center, or in a cloud with cloud-based scaling points.

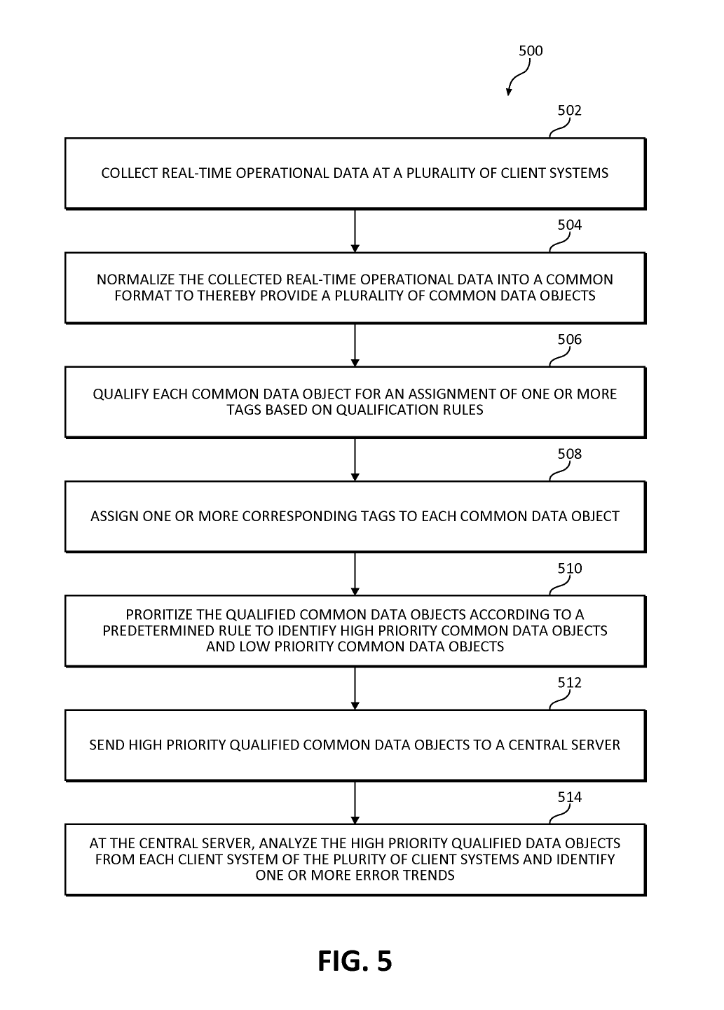

FIG. 5 is a flow diagram of a method 500 of managing data objects using the logging server appliance, in accordance with an embodiment. The method 500 includes collecting real-time operational data at a plurality of client systems at 502. In an embodiment, the operational data includes, but is not limited to, log messages, messages of regulatory importance, error messages, debug messages, information messages, statistical data, performance data, system health measures, system events, gaming events, operating system events, and hardware errors. The plurality of client systems includes logging systems, gaming systems, casino management systems, floor management systems, bonusing systems, progressive systems, table systems, cashless systems, ticketing systems, and floor systems, and the common data objects comprise common data objects. The operational data is collected from multiple data sources each having a different log format.

Next, the collected real-time operational data is normalized into a common format to thereby provide a plurality of common data objects at 504. After the objects are normalized, each common data object is qualified for an assignment of one or more tags based on qualification rules at 506. One or more corresponding tags are assigned to each common data object at 508. Then, the qualified common data objects are prioritized according to a predetermined rule to identify high priority common data objects and low priority common data objects at 510. In an embodiment, the predetermined rule is replaced with a new predetermined rule, and the qualified common data objects are then re-prioritized according to the new predetermined rule.

The high priority qualified common data objects are sent to a central server at 512. As noted above, a corresponding tag of a high priority qualified data object is associated with a resolution, in an embodiment. As such, the resolution associated with the corresponding tag of the high priority qualified data object is identified, and in response to the identifying, a resolution script associated with the resolution is run, in an embodiment. In step 514, at the central server, the high priority qualified data objects from each client system of the plurality of client systems are analyzed and one or more error trends are identified, based on the analyzing.

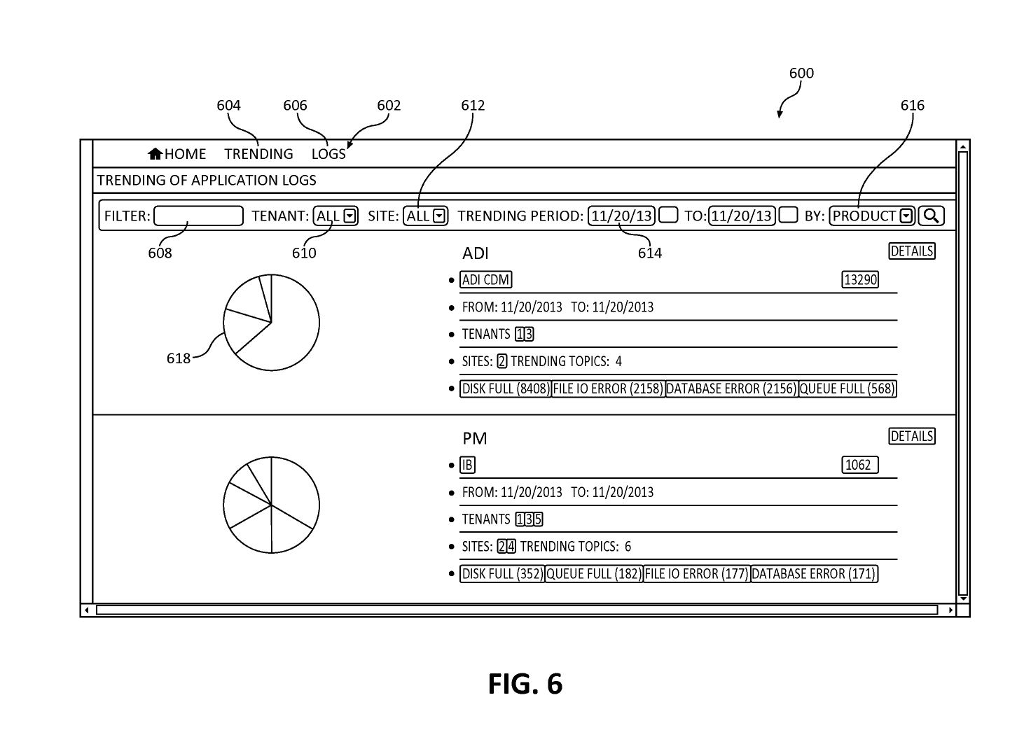

FIG. 6 is a screen shot illustrating an example logging server appliance interface 600, according to an embodiment. The logging server appliance interface 600 includes a menu bar 602 including a trending button 604 and a logs button 606. When selected, the trending button 604 pulls up identified trends according to a filter range and presents the trends to a user. In this regard, the interface 600 provides areas in which to input a filter phrase 608, a tenant pull down menu 610 from which to select a tenant who is part of the community, a site pull down menu 612 from which to select a site of interest, a trending period input area 614 to input a date range of interest, and a product pull down menu 616 for the selection of a particular product. In the screenshot of FIG. 6, a date range of Nov. 20, 2013 was specified, and the logging server appliance interface 600 identified various trending topics across all of the tenants, which include “DiskFull,” “File IOErrors,” “DatabaseError,” and “QueueFull.” As illustrated in FIG. 6, the trends are associated with various products (e.g., ADI and PM) and the tenants and sites exhibiting the symptoms while running the particular products in the trending topics are identified. Pie charts 618 or other visual aids are provided to the community users.

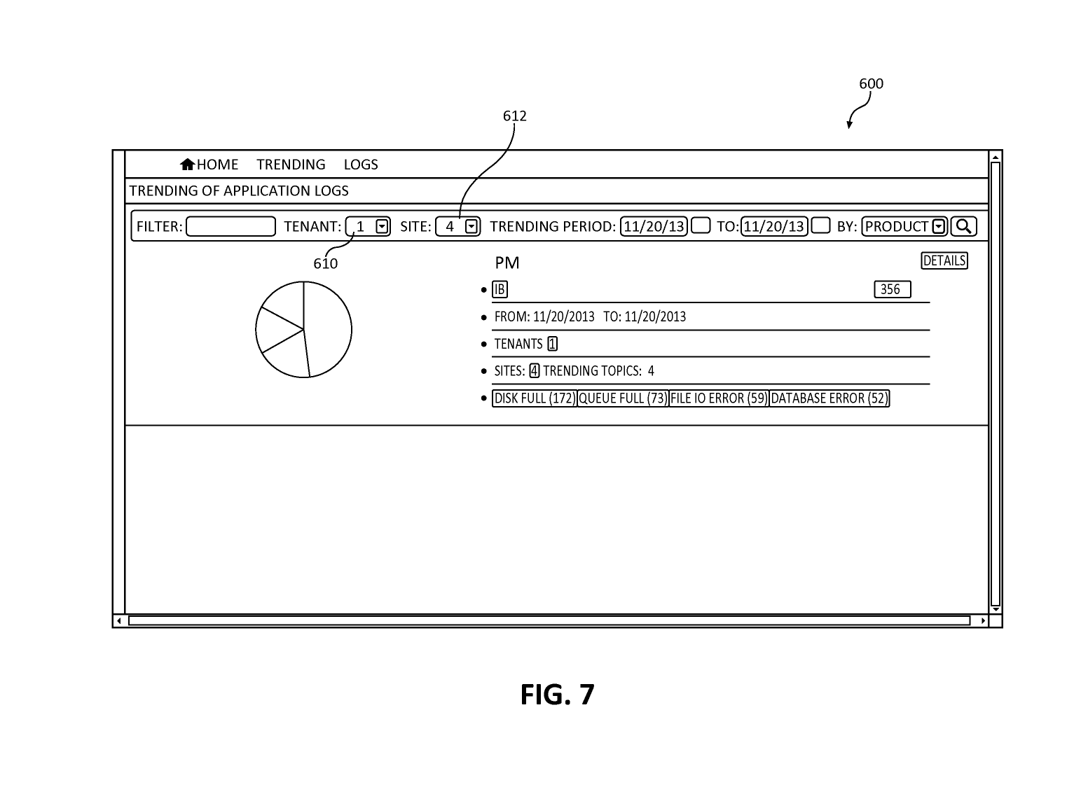

FIG. 7 is a screenshot of the logging server appliance interface 600 including information regarding a particular tenant and site. Here, a particular tenant (e.g., Tenant 1) is selected from the tenant pull down menu 610, and a particular site (e.g., Site 4) is selected from the site pull down menu 612. The specific trending topics are shown (e.g., “DiskFull,” “File IOErrors,” “DatabaseError,” and “QueueFull”).

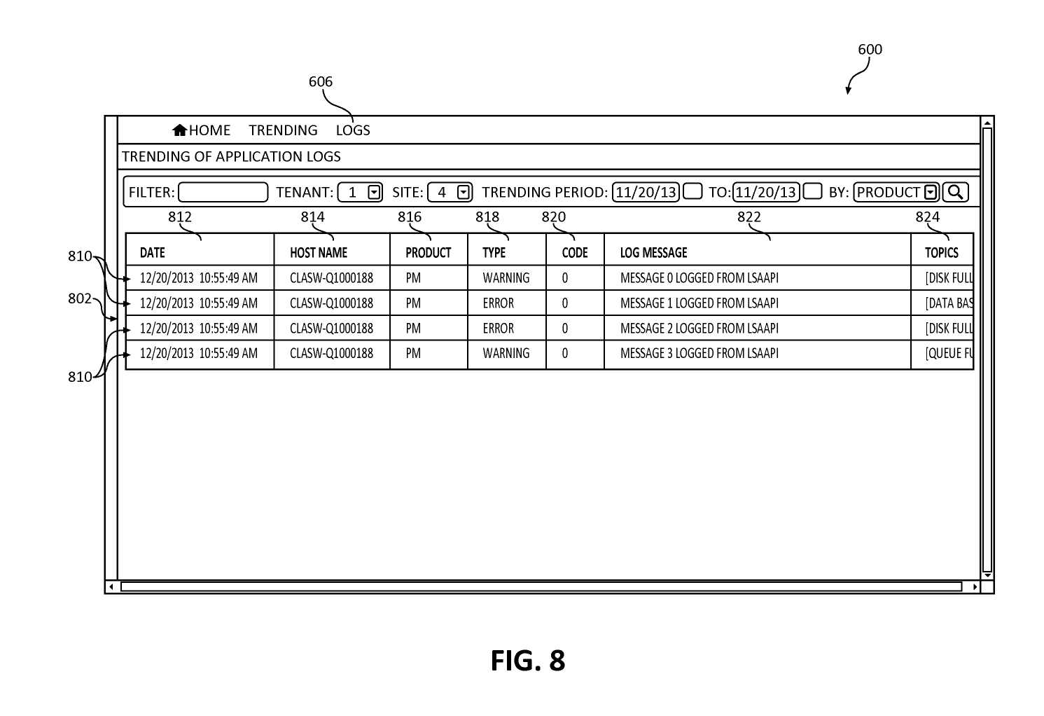

In an embodiment in which a user desires to pull up the data object information that correlates to the trending topics, the user clicks on the logs button 606. FIG. 8 is a screenshot of a logging server appliance 600, according to another embodiment in which the logs button 606 was pressed. Here, a log 802 is shown including multiple entries 810, and information organized by categories including the date 812, a host name 814, the product name 816, type of message 818 (e.g., a warning or error message), code 820, log message 822, and topics 824 that are associated with the log message 822. A user clicks the entry to view raw log data associated with the entry and the entries can be downloaded as log files or as a spreadsheet for further viewing and analysis.

By including the logging server appliance 300, data from multiple sources are centralized into one unified format. The data is correlated chronologically by a common time source to thereby intuitively reflect a current state of the system spanning over time. As a result, analysis of the data can pinpoint root causes of an error or issue in a virtualized environment. Additionally, because a community of users determines how data objects age, which data objects to store, what weight to assign each item, and the like, the system is dynamic and self-maintaining. The assignment of tags to the data objects normalizes the data such that comparative analysis can be performed on the data and trends can be identified from the analyses.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

What is claimed is:

1. A method of managing operational data, the method comprising:
collecting real-time operational data at a plurality of client systems;
at each client system:
normalizing the collected real-time operational data into a common format to thereby provide a plurality of common data objects;
qualifying each common data object for an assignment of one or more tags based on qualification rules;
assigning one or more corresponding tags to each common data object; and
prioritizing the qualified common data objects according to a predetermined rule to identify high priority common data objects and low priority common data objects; and
sending the high priority qualified common data objects to a central server.

2. The method of claim 1, wherein:
the operational data includes one or more of log messages, messages of regulatory importance, error messages, debug messages, information messages, statistical data, performance data, system health measures, system events, gaming events, operating system events, and hardware errors; and
the plurality of client systems includes one or more of logging systems, gaming systems, casino management systems, floor management systems, bonusing systems, progressive systems, table systems, cashless systems, ticketing systems, and floor systems.

3. The method of claim 1, further comprising replacing the predetermined rule with a new predetermined rule, and re-prioritizing the qualified common data objects according to the new predetermined rule.

4. The method of claim 1, wherein the step of collecting comprises collecting the operational data from multiple data sources each having a different log format.

5. The method of claim 1, further comprising associating one or more corresponding tags of one or more high priority qualified data objects with one or more resolutions.

6. The method of claim 5, further comprising:
identifying the one or more resolutions associated with the one or more corresponding tags of the one or more high priority qualified data objects, and
in response to the identifying, running one or more resolution scripts associated with each resolution.

7. The method of claim 1, further comprising analyzing at the central server the high priority qualified data objects from each client system of the plurality of client systems and identifying one or more error trends, based on the analyzing.

8. A system for managing operational data comprising:
one or more processing devices in communication with one or more memories including instructions that when executed by the one or more processing devices cause the one or more processing devices to perform the steps of:
collecting real-time operational data at a plurality of client systems;
at each client system:
normalizing the collected real-time operational data into a common format to thereby provide a plurality of common data objects,
qualifying each common data object for an assignment of one or more corresponding tags based on qualification rules;
assigning one or more corresponding tags to each common data object;
and
prioritizing the qualified common data objects according to a predetermined rule to identify high priority common data objects and low priority common data objects; and
sending the high priority qualified common data objects to a central server.

9. The system of claim 8, wherein:
the operational data includes one or more of log messages, messages of regulatory importance, error messages, debug messages, information messages, statistical data, performance data, system health measures, system events, gaming events, operating system events, and hardware errors; and
the plurality of client systems includes one or more of logging systems, gaming systems, casino management systems, floor management systems, bonusing systems, progressive systems, table systems, cashless systems, ticketing systems, and floor systems.

10. The system of claim 8, wherein the one or more memories include additional instructions that when executed by the one or more processing devices cause the one or more processing devices to perform the steps of:
receiving a vote up or a vote down of the qualification rules by members of a community; and
in response to the vote up or the vote down, re-prioritizing the qualification rules that have been voted down as low priority and re-prioritizing the qualification rules that have been voted up as high priority, thereby causing the one or more corresponding tags applied to the common data objects to be prioritized according to the priority of the rule that tagged the common data objects.

11. The system of claim 8, wherein the processing device further is, during the collecting, collecting the operational data from multiple data sources each having a different log format.

12. The system of claim 8, wherein the processing device further is associating one or more corresponding tags of a high priority qualified data object with one or more resolutions.

13. The system of claim 12, wherein the processing device further is:
identifying the one or more resolutions associated with the one or more corresponding tags of the one or more high priority qualified data objects, and
in response to the identifying, running one or more resolution scripts associated with the one or more resolutions.

14. The system of claim 8, wherein the processing device further is analyzing at the central server the high priority qualified data objects from each client system of the plurality of client systems and identifying one or more error trends, based on the analyzing.

15. A computer program product comprising a computer-readable storage medium having computer-readable program code portions stored therein, the computer-readable program code portions comprising:
computer code for collecting real-time operational data at a plurality of client systems;
computer code for, at each client system:
normalizing the collected real-time operational data into a common format to thereby provide a plurality of common data objects,
qualifying each common data object for an assignment of one or more corresponding tags based on qualification rules;
assigning one or more corresponding tags to each common data object;
and
prioritizing the qualified common data objects according to a predetermined rule to identify high priority common data objects and low priority common data objects; and
computer code for sending the high priority qualified common data objects to a central server.

16. The computer program product of claim 15, wherein:
the operational data includes one or more log messages, messages of regulatory importance, error messages, debug messages, information messages, statistical data, performance data, system health measures, system events, gaming events, operating system events, and hardware errors; and
the plurality of client systems includes one or more logging systems, gaming systems, casino management systems, floor management systems, bonusing systems, progressive systems, table systems, cashless systems, ticketing systems, and floor systems.

17. The computer program product of claim 15, further comprising computer code for, during the collecting, collecting the operational data from multiple data sources each having a different log format.

18. The computer program product of claim 15, further comprising computer code for associating one or more corresponding tags of one or more high priority qualified data objects with one or more resolutions.

19. The computer program product of claim 18, further comprising:
computer code for identifying the one or more resolutions associated with the one or more corresponding tags of the one or more high priority qualified data objects, and
computer code for, in response to the identifying, running one or more resolution scripts associated with each resolution.

20. The computer program product of claim 15, further comprising:
computer code for analyzing at the central server the high priority qualified data objects from each client system of the plurality of client systems and identifying one or more error trends, based on the analyzing.
